(19) United States
(12) Patent Application Publication
(10) Pub. No.: US 2016/0285346 A1
(43) Pub. Date: Sep. 29, 2016

(54) COOLING DEVICE FOR MOTOR

(71) Applicants: Russel Hugh Marvin, Goshen, CT (US); David H. Leach, Torrington, CT (US)

(72) Inventors: Russel Hugh Marvin, Goshen, CT (US); David H. Leach, Torrington, CT (US)

(21) Appl. No.: 15/082,796

(22) Filed: Mar. 28, 2016

Related U.S. Application Data
(60) Provisional application No. 62/139,282, filed on Mar. 27, 2015.

(51) Int. Cl. H02K 9/22

(52) U.S. Cl. CPC H02K 9/22

(57) ABSTRACT

A cooling device for a motor winding having a first end turn and a second end turn and extending around a stator tooth having a first axial end surface and a second axial end surface includes a cradle portion. A cover portion cooperates with the cradle portion to define an interior space for receiving the first end of the winding to space the first end from the first axial end surface of the stator tooth.

### RELATED APPLICATIONS

This application claims the benefit of U.S. Provisional Application Ser. No. 62/139,282, filed Mar. 27, 2015, the entirety of which is incorporated herein by reference.

### TECHNICAL FIELD

The invention relates to a motor stator and, in particular, relates to a cooling device for windings in a motor stator.

### BACKGROUND

Most motors generate heat in the copper winding (I²R losses) and transfer that heat through the ground wall electrical insulation. The heat then has to go through the steel laminations to get to the heat-sink. Unfortunately, steel is a very poor conductor and becomes the rate limiting step in heat transfer. Consequently, in this configuration the motor needs to be larger and weigh more to be able to dissipate the heat, which his undesirable since motor space can be at a premium.

### SUMMARY OF THE INVENTION

In accordance with an aspect of the present invention, a cooling device for a motor winding having a first end turn and a second end turn and extending around a stator tooth having a first axial end surface and a second axial end surface includes a cradle portion. A cover portion cooperates with the cradle portion to define an interior space for receiving the first end of the winding to space the first end from the first axial end surface of the stator tooth.

In accordance with another aspect of the invention, motor stator includes a stator body centered on an axis and having a plurality of radially extending teeth spaced apart to define circumferential slots. Each tooth has a first axial end surface and a second axial end surface. A motor winding is wound around each tooth. Each winding has a first end turn wound around the first axial end surface of each tooth and a second end turn wound around the second axial end surface of teach tooth. A cooling device removes heat from the first end turn. The cooling device includes a cradle portion and a cover portion that cooperate to define an interior space for receiving the first end turn to space the first end turn from the first axial end surface of the stator tooth.

Other objects and advantages and a fuller understanding of the invention will be had from the following detailed description of the preferred embodiments and the accompanying drawings.

### BRIEF DESCRIPTION OF THE DRAWINGS

FIG. 1 is a schematic illustration of an actuator in accordance with an aspect of the present invention.

FIG. 2 is a section view of the actuator of FIG. 1 taken along line 2-2.

FIG. 3 is an exploded view of the actuator of FIG. 1.

FIG. 4A is a section view of a motor of FIG. 3 taken along line 4A-4A.

FIG. 4B is an enlarged view of a portion of the motor of FIG. 4A.

FIG. 4C is a section view of the motor of FIG. 4A taken along line 4C-4C.

FIG. 4D is a section view of the motor of FIG. 4A taken along line 4D-4D.

FIG. 5A is a front view of a portion of a cooling device for the motor.

FIG. 5B is a top view of the cooling device portion of FIG. 5A.

FIG. 6 is a front view of the cooling device when assembled.

### DETAILED DESCRIPTION

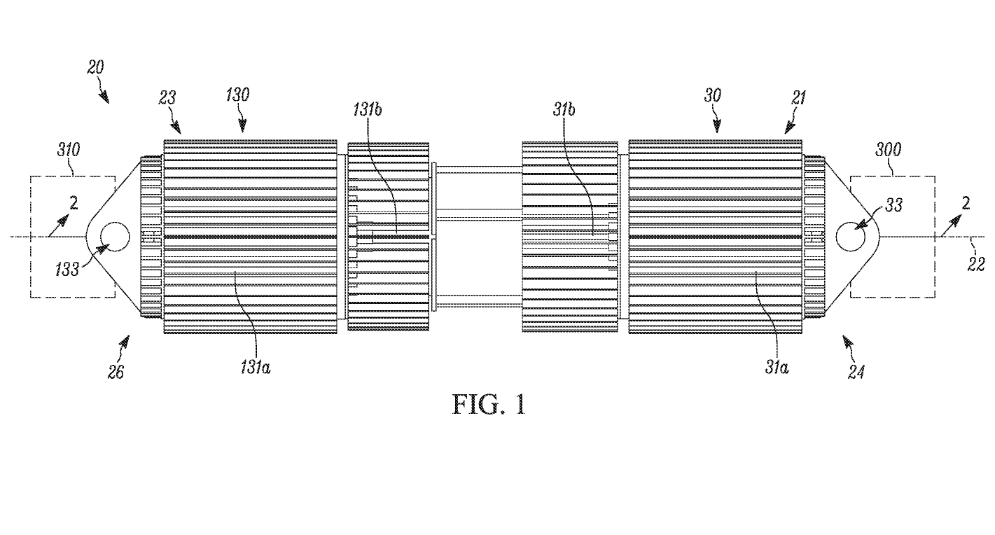

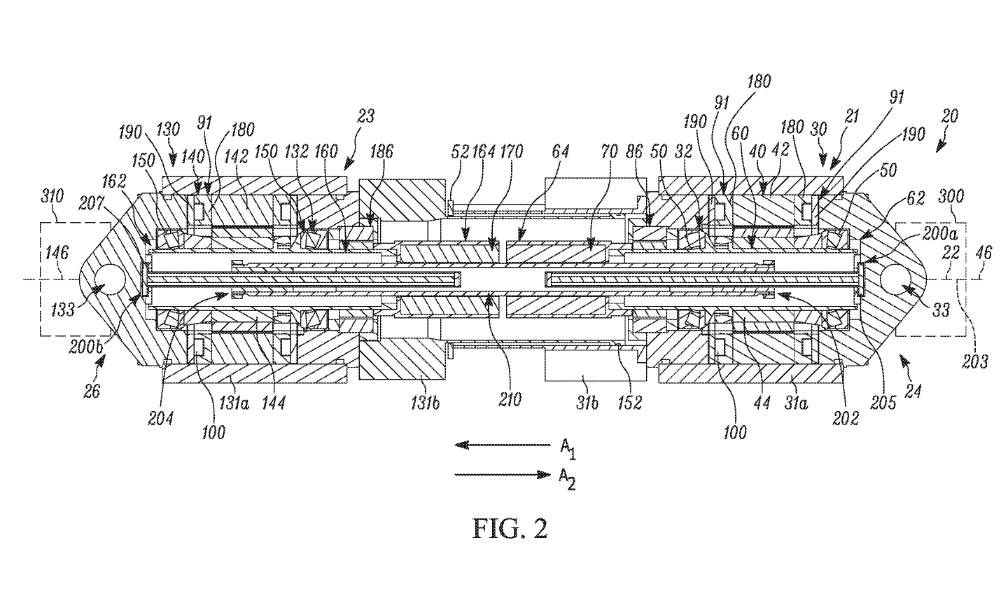

The invention relates to a motor stator and, in particular, relates to a cooling device for windings in a motor stator. In one example, the motor is used to drive an actuator for critical flight components of an aircraft, although the motor described herein could also be used for any application where a more compact motor is desired. FIGS. 1-3 illustrate an actuator 20 connecting two components (shown schematically in FIGS. 1 and 2 at 300, 310) in accordance with an embodiment of the present invention.

The first and second components 300, 310 can be components of an aircraft. In one example, the first component 300 is the main body or fuselage of the aircraft and the second component 310 is a critical flight-control mechanism, e.g., the rudder or ailerons. It will be appreciated, however, that the components 300, 310 can constitute other parts of an aircraft or any other device where electrically operated actuation is desirable.

Referring to FIGS. 1 and 2, the actuator 20 is elongated and extends along a centerline 22 from a first end 24 to a second end 26. The actuator 20 includes a pair of actuating mechanisms 21, 23 movable relative to one another along the centerline 22. More specifically, the actuating mechanism 21 includes a first housing 30 and the actuating mechanism 23 includes a second housing 130 slidably connected to one another in a telescoping manner.

The first housing 30 has a tubular shape and includes a pair of interconnected portions 31a, 31b that cooperate to define an interior 32 in which a motor 40 is provided. An opening 33 extends through the exterior of the portion 31a. The opening 33 is aligned with the centerline 22 of the actuator 20 and is used to attach the portion 31a to the first aircraft component 300. The portion 31b of the first housing 30 includes a flange 52 having a portion extending radially inward into the interior 32.

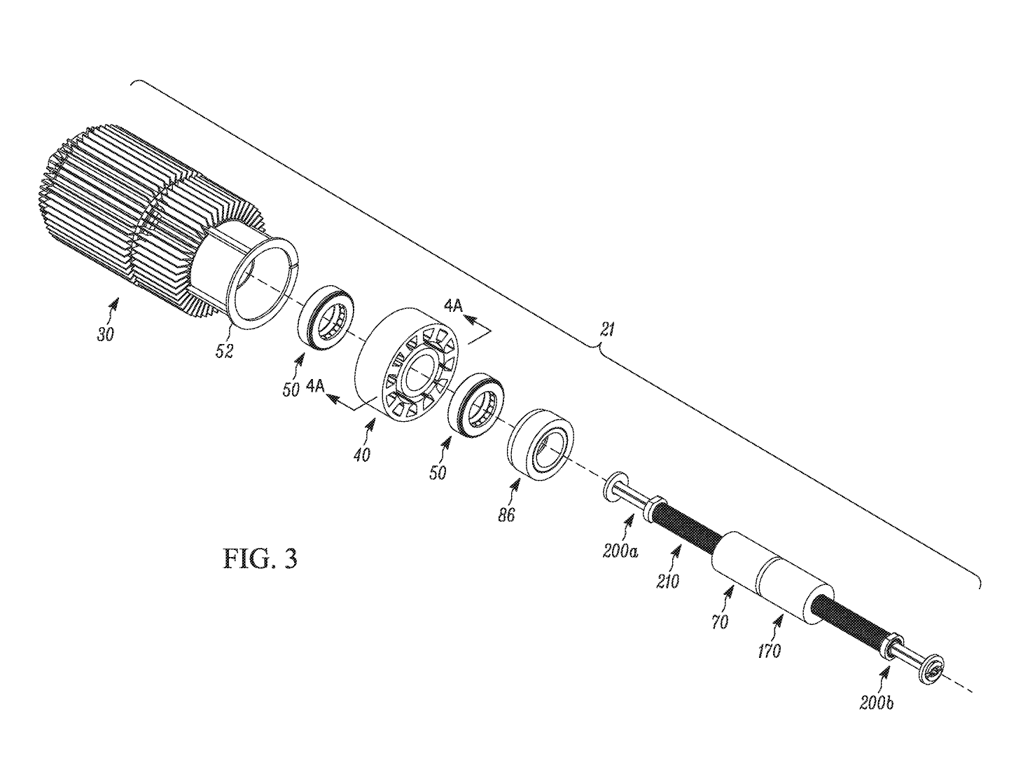

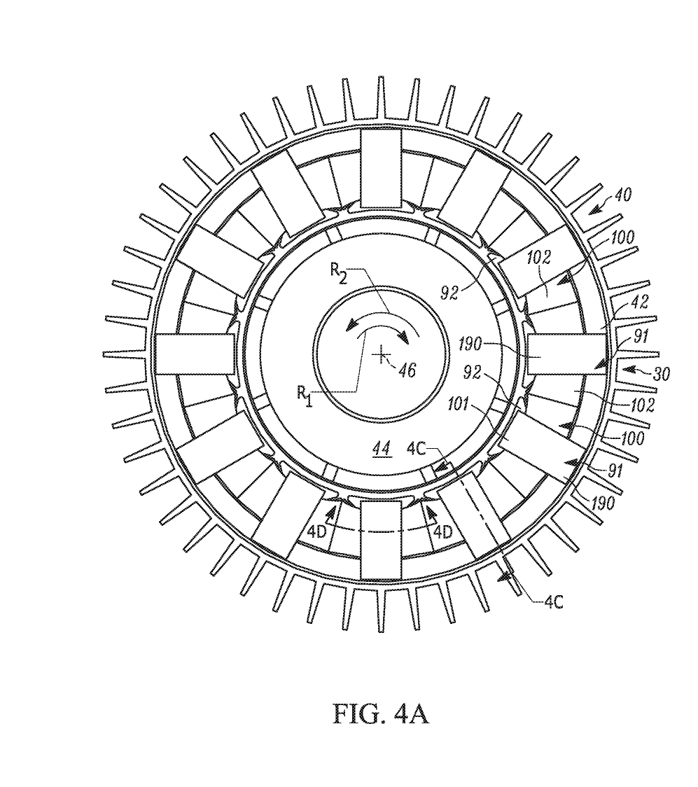

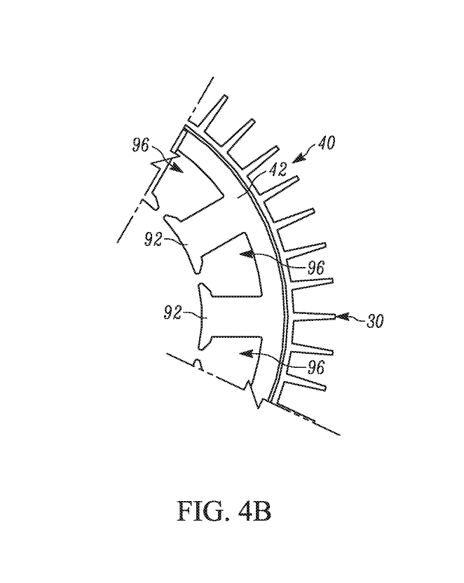

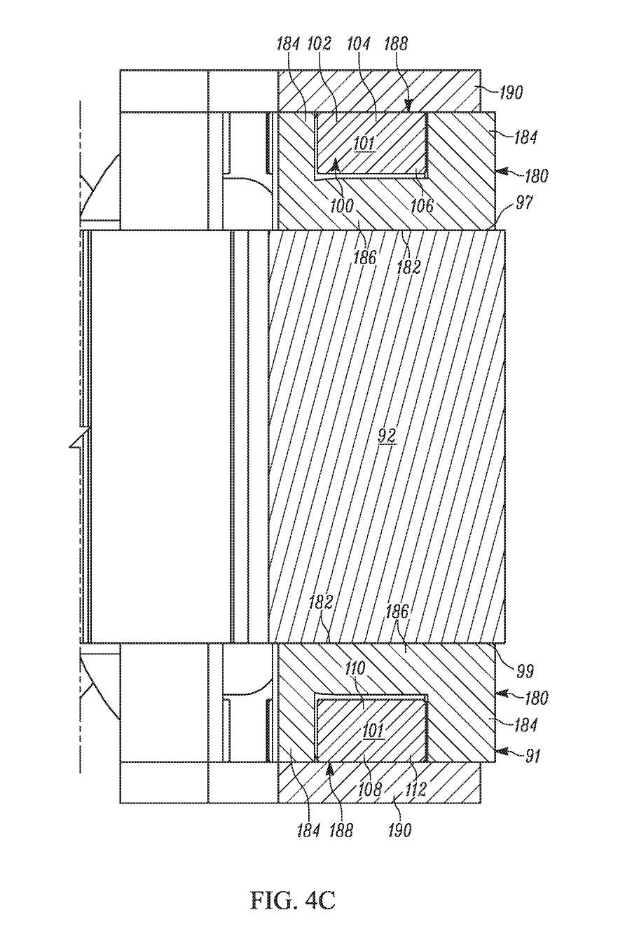

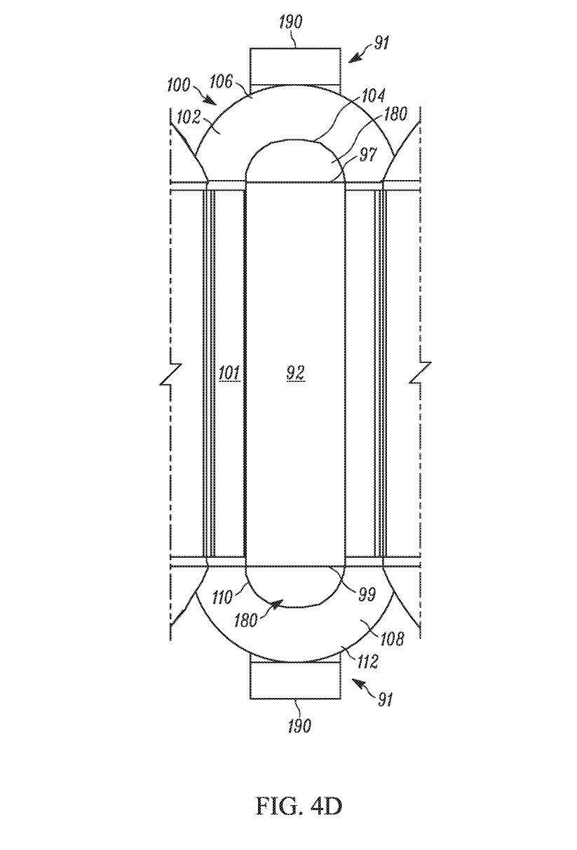

Referring to FIGS. 3 and 4, the motor 40 is a conventional permanent magnet (PM) motor that includes a stator 42 fixed to the first housing 30 and a rotor 44 rotatable about an axis 46 within and relative to the stator in a known manner. One or more bearings 50 are also positioned within the interior 32 and connected to the first housing 30. As shown, two bearings 50 are provided on opposite sides of the motor 40 centered on the rotational axis 46 of the rotor 44. The bearings 50 constitute roller thrust bearings having an annular shape, such as those shown and described in U.S. 2015/0276029, the entirety of which is incorporated herein by reference.

Referring to FIGS. 2 and 3, the actuator mechanism 21 further includes a tubular shaft 60 secured to and rotatable with the bearings 50 and the rotor 44. The shaft 60 extends from a first end 62 within the portion 31a of the first housing 30 to a second end 64 within the portion 31b of the first housing.

A roller nut 70 is fixed to, e.g., threadably engaged with, the second end 64 of the shaft 60 such that rotation of the motor 44 rotates the nut 70. The nut 70 has a fixed longitudinal position within the actuating mechanism 21. The nut 70 includes an inner surface defining a passage (not shown) extending longitudinally through the entire nut.

An annular resolver 86 (FIGS. 2 and 3) encircles the shaft 60 and is positioned longitudinally between the roller nut 70 and the motor 40. The resolver 86 senses and monitors the angular position of the shaft 60 about the axis 46. The resolver 86 is constructed of windings on steel cores (not shown) and contains no electronic components and, thus, the resolver has low failure rates similar to motor windings.

FIGS. 4A-4D provide more detail of the motor 40 of the actuating mechanism 21. Referring to FIGS. 4A-4B, the stator 42 is centered on the axis 46 and encircles the rotor 44. The rotor 44 can be constructed with a surface mount, permanent magnet topology or an internal permanent magnet topology. In one example, the rotor 44 has an eight pole configuration using 40 UH neodymium magnets.

The stator 42 can be formed from a series of conductive plates stacked axially atop one another and laminated together. The stator 42 defines a series of teeth 92 that each extends radially inward towards the axis 46. Each tooth 92 also extends longitudinally in a direction parallel to the axis 46 from a first axial end surface 97 to a second axial end surface 99.

Slots or passages 96 extend along the length of the stator 42 between consecutive pairs of teeth 92. In one example, the stator 42 has an eight pole, twelve slot configuration or otherwise has the same configuration as the rotor 44. One or more electrically conductive windings 100 loop around each tooth 92 in the axial direction so as to extend through the passages 96 on either side of each tooth.

Referring to FIGS. 4C-4D, each winding 100 has a first end turn 102 adjacent to and extending around the first axial end surface 97 of the respective tooth 92. Each winding 100 also has a second end turn 108 adjacent to and extending around the second axial end surface 99 of the respective tooth 92. The windings 100 are generally round/elliptical and therefore the first end turn 102 has a radially inner portion 110 adjacent the first axial end surface 97 and a portion 112 radially outward of the inner portion 110. The second end turn 108 has a radially inner portion 104 adjacent the first axial end 97 and a portion 106 radially outward of the inner portion 104.

The windings 100 can be concentrated wound to optimize weight and performance. In one example, each winding 100 has 81 turns of 20 ga copper wire so it can be relatively easily wound. Once wound, the winding 100 wires are coated with varnish or insulation tape before the winding is ultimately covered in ground wall insulation 101 which could be nomex, mica, or similar slot liner.

Applying electrical current to the windings 100 causes the rotor 44 to rotate about the axis 46 relative to the stator 42 in a first direction R₁ or a second, opposite direction R₂ as shown in FIG. 4A. The motor 40 is capable of handling continuous torque.

The motor 40 is cooled by novel cooling devices 91 in accordance with the present invention. The cooling devices 91 are provided adjacent one or both end turns 102, 108 of at least one winding 100 in the stator 42. As shown, both end turns 102, 108 of every winding 100 are provided with cooling devices 91. The cooling devices 91 act as conduction elements that pull heat from the end turns 102, 108, with heat in the passage 96 being conducted to the end turns by the copper wire of the windings 100. In doing so, the temperature drop in the motor 40 is minimized while convective losses on the exterior of the motor are maximized.

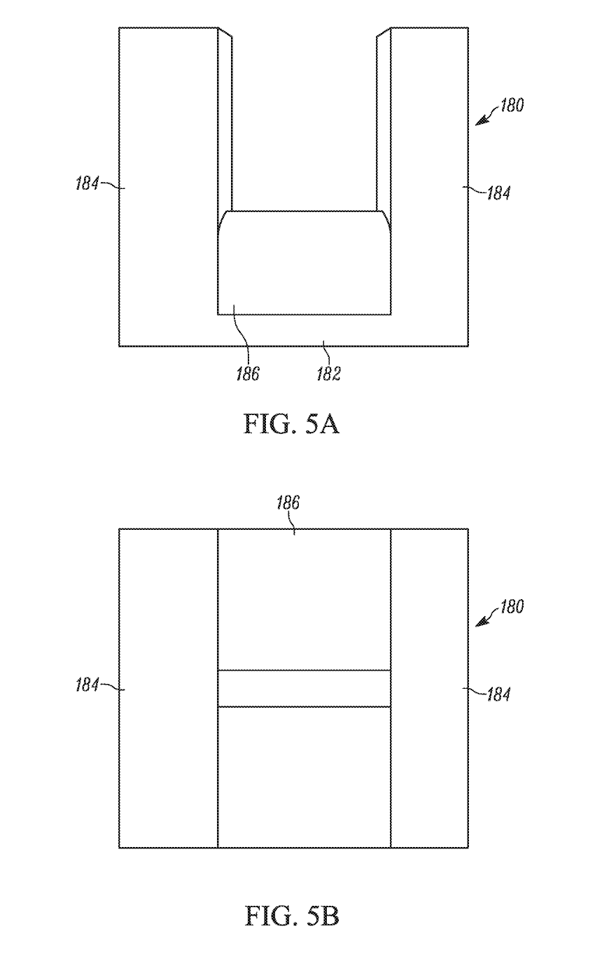

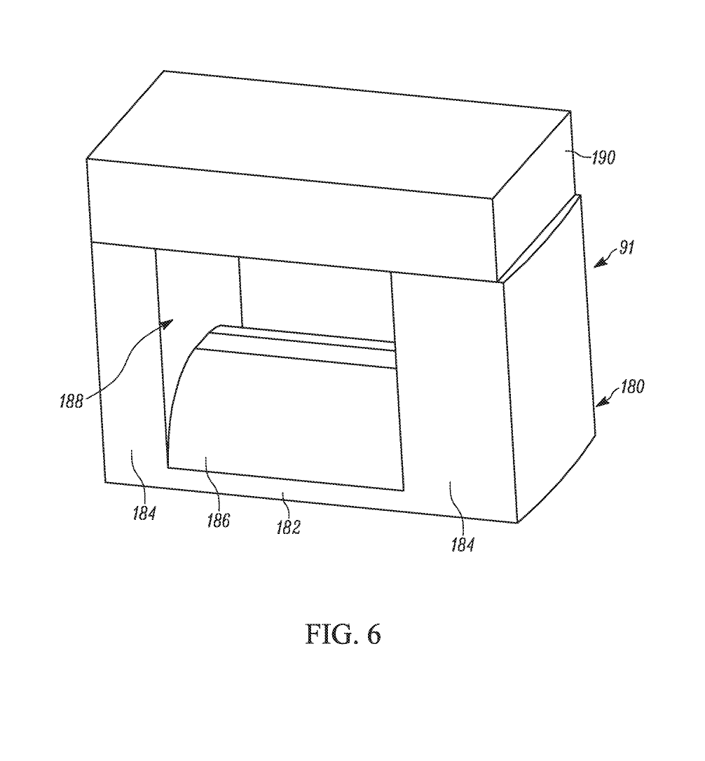

Referring to FIGS. 5A-6, each cooling device 91 includes a first or cradle portion 180 and a second or cover portion 190. The cradle portion 108 includes a base 182 and a pair of opposing legs 184 and, thus, the cradle portion is C-shaped. A rounded projection 186 extends from the base 182. The projection 186 can have a generally cylindrical shape extending longitudinally between the legs 184. The cover portion 190 is shown as planar, but alternatively could be C-shaped (not shown). The cradle portion 180 and cover portion 190 are formed from a thermally conductive material(s), e.g., aluminum.

The cradle portion 180 and cover portion 190 cooperate to define an interior space 188. The interior space 188 is sized and shaped to receive either the first end turn 102 or the second end turn 108 of one of the windings 100. Referring to FIGS. 4C-4D, one cooling device 91 is positioned around the first end turn 102 so as to encircle the first end turn. The cradle portion 180 engages the first axial end surface 97 of the tooth 92 and the groundwall insulation 101 on the inner portion 104 of the first end turn 102. More specifically, the inner portion 104 extends over, and generally follows the contour of, the projection 186.

The cover portion 190 is secured to the legs 184 of the cradle portion 180 to position the first end turn 102 in the interior space 188. In this position, the cover portion 190 engages the groundwall insulation 101 on the outer portion 106 of the first end turn 102. Since the cooling device 91 engages both radial sides 104, 106 of the first end turn 102 it is capable of drawing heat out of multiple surfaces on the winding 100, thereby increasing the cooling effect.

Another cooling device 91 is positioned around the second end turn 108 so as to encircle the second end turn. The cradle portion 180 engages the second axial end surface 99 of the tooth 92 and the ground wall insulation 101 on the inner portion 110 of the second end turn 108. More specifically, the inner portion 110 extends over, and follows the contour of, the projection 186.

The cover portion 190 is secured to the legs 184 of the cradle portion 180 to position the second end turn 108 in the interior space 188. In this position, the cover portion 190 engages the groundwall insulation 101 on the outer portion 112 of the second end turn 108. Since the cooling device 91 engages both radial sides 110, 112 of the second end turn 108 it is capable of drawing heat out of multiple surfaces on the winding 100, thereby increasing the cooling effect.

Referring to FIGS. 1 and 2, the second housing 130 of the actuating mechanism 23 has a tubular shape and includes a pair of interconnected portions 131a, 131b that cooperate to define an interior 132 in which a motor 140 is provided. An opening 133 extends through the exterior of the portion 31a. The opening 133 is aligned with the centerline 22 of the actuator 20 and is used to attach the portion 131a to the second component 310. The portion 131b of the second housing 130 includes a flange 152 extending radially outward into engagement with the interior of the portion 31b of the first housing 30. An o-ring seal (not shown) helps form a fluid-tight connection between the housings 30, 130 adjacent the flange 152.

The motor 140 is a conventional PM motor that includes a stator 142 fixed to the second housing 130 and a rotor 144 rotatable about an axis 146 within and relative to the stator in a known manner. One or more bearings 150 are also positioned within the interior 132 and connected to the second housing 130. As shown, two bearings 150 are provided on opposite sides of the motor 140 centered on the rotational axis 146 of the rotor 144. It will be appreciated that the motor 140 and bearings 150 have the same construction as the motor 40 and bearings 50, respectively. Therefore, a more detailed discussion of the motor 140 and bearings 150 is omitted for brevity.

The motor 140 includes at least one of the cooling devices 91 provided on one or more end turns 102, 108 of at least one winding 100. Although not shown, in this example every winding 100 in the motor 140 includes the cooling device 91 at each end turn 102, 108 and, thus, the motors 40, 140 are cooled in the same manner. It will be appreciated that the motors 40, 140 could alternatively be provided with different cooling device arrangements to meet design criteria.

The actuating mechanism 23 further includes a tubular shaft 160 secured to and rotatable with the bearings 150 and the rotor 144. The shaft 160 extends along the centerline 22 from a first end 162 within the portion 131a of the second housing 130 to a second end 164 within the portion 131b of the second housing.

A roller nut 170 is fixed to, e.g., threadably engaged with, the second end 164 of the shaft 160 such that rotation of the motor 140 rotates the nut 170. The nut 170 has a fixed longitudinal position within the actuating mechanism 23. The nut 170 further includes a threaded inner surface defining a passage (not shown) extending longitudinally through the entire nut.

An annular resolver 188 encircles the shaft 160 and is positioned longitudinally between the roller nut 170 and the motor 140. The resolver 188 senses and monitors the angular position of the shaft 160 about the axis 146. The resolver 188 has the same construction as the resolver 86.

A screw 210 positioned within the interiors 32, 132 of the housings 30, 130 and transmits longitudinal/axial movement between the first and second aircraft components 300, 310 secured to the actuating mechanisms 21, 23. The screw 210 can be tubular or solid (not shown) and constitute any known screw type, e.g., roller screw or ball screw. In the present example, the screw 210 is a tubular roller screw that extends along a centerline 203 from a first end 202 to a second end 204. The first end 202 is secured to the interior of the first housing 30. The second end 204 is secured to the interior of the second housing 130. The centerline 203 of the roller screw 210 is coaxial with the centerline 22 of the actuator 20 and the axes 46, 146 of the motors 40, 140. The roller screw 210 is threadably engaged with the nuts 70, 170 (see FIG. 2). The roller screw 210 is made from a non-magnetic material, such as hardened stainless steel or a Ni—Cr alloy with a coating to provide surface hardness.

Referring to FIGS. 2-3, a linear variable differential transformer (LVDT) 200a, 200b is provided at each end 202, 204 of the roller screw 210. An example LVDT is illustrated and described in the aforementioned U.S. 2015/0276029 incorporated by reference herein. Each LVDT 200a, 200b senses the linear distance between the end 202, 204 of the roller screw 210 and the associated end 24, 26 of the actuator 20. Consequently, each LVDT 200a, 200b measures its position with respect to the roller screw 210 as the actuating mechanisms 21, 23 move relative to one another. Each LVDT 200a, 200b is also inverted compared to conventional LVDTs.

Referring to FIGS. 1 and 2, when it is desirable to move the second component 310 longitudinally in a first direction A₁ along the axis 22, the first motor 40 rotates in the direction R₁, causing the nut 70 to rotate in the direction R₁. Since the first nut 70 has a fixed longitudinal position relative to the housing 30, and the LVDT 200a prevents rotation of the roller screw 210, rotation of the first nut 70 in the direction R₁ causes the roller screw to move longitudinally along the centerline 22 in the direction A₁. Consequently, the distance between the nuts 70, 170 increases.

If motor 140 is not spinning, the longitudinal movement A₁ is transferred from the roller screw 210 to the nut 170 and ultimately to the rest of the actuating mechanism 23, thereby moving the actuating mechanism 23 in the direction A₁ . The LVDT 200b maintains the same relative relationship with the roller screw 210 when the motor 140 is not actuated, i.e., there is no relative movement between the LVDT 200b and roller screw.

The motor 140 can be actuated in lieu of or in addition to actuating the motor 40 to move the actuating mechanism 23 in the direction A₁. The only difference is that the motor 140 is rotated in the direction R₂ opposite the direction R₁ to longitudinally move the second component 310 relative to the first component 300 in the direction A₁. Otherwise, the interaction between the rotating nut 170 and roller screw 210 is identical to the interaction of the nut 70 with the roller screw when the motor 40 is rotated in the direction R₁. When the motor 140 rotates in the direction R₂, the distance between the nuts 70, 170 increases.

When it is desirable to move the second component 310 in a second direction A₂ opposite the first direction A₁, the above process is reversed. In particular, the first motor 40 is rotated about the axis 46 in the direction R₂. This causes the roller screw 210 and actuating mechanism 23 secured thereto to move longitudinally in the direction A₂ relative to the rotating nut 70. Consequently, the distance between the nuts 70, 170 decreases.

As with movement of the roller screw 210 in the direction A₁, the motor 140 can be actuated in lieu of or in addition to the motor 40 to move the actuating mechanism 23 in the direction A₂. The only difference is that the motor 140 is rotated in the direction R₁ opposite the direction R₂ in order to longitudinally move the second component 310 relative to the first component 300 in the direction A₂. When the motor 140 rotates in the direction R₁, the distance between the nuts 70, 170 decreases.

During operation of the motors 40 and/or 140, heat is generated in the copper windings 100 as current passes therethrough. Advantageously, the cooling device 91 on each end turn 102, 108 of the windings 100 removes heat from those end turns. The stack length of the stators 42, 142 is short and, thus, the temperature gradient through the axial length of the stators is quite low, e.g., about 5° C., due to the high conductivity of the copper. The groundwall insulation 101 between the cradle portions 180 and the copper winding 100 wire is highly conductive and pulls the heat out of the copper wire much better than conventional ground wall insulation.

Copper has quite a high conductivity of about 400 W/mK. However, the groundwall insulation 101 around the winding 100 wires, and the varnish impregnated between them after winding, has a very low thermal conductivity of about 0.25 W/mK. Even though the groundwall insulation 101 is quite thin—taking up less than 10% of the diameter—the transverse thermal conductivity is 2 W/mK of a wire bundle. As a result, the thermal conductivity of the groundwall insulation 101 becomes the rate limiting thermal conductor in the thermal calculator. This results in a large fraction of the temperature rise occurring within the windings 100.

If heat were only removed off one face/side of the winding 100, the temperature drop through the winding would be about 28° C. By taking the heat off both sides, i.e., the radially inner and outer portions 104/106 and 110/112, respectively, of the end turns 102, 108, the temperature drop is reduced by nearly 4×. In this case, heat is advantageously removed from both the inner portions 104, 110 [by the cradle portions 180] and the outer portions 106, 112 [by the cover portions 190]. Using this unique cooling device 91 construction, coupled with the high thermally conductive groundwall insulation 10, the temperature drop from the worst case wire to the heat-sink will be less than about 44° C.

The preferred embodiments of the invention have been illustrated and described in detail. However, the present invention is not to be considered limited to the precise construction disclosed. Various adaptations, modifications and uses of the invention may occur to those skilled in the art to which the invention relates and the intention is to cover hereby all such adaptations, modifications, and uses which fall within the spirit or scope of the appended claims.

Having described the invention, the following is claimed:

1. A cooling device for a motor winding having a first end turn and a second end turn and extending around a stator tooth having a first axial end surface and a second axial end surface, comprising:
a cradle portion; and
a cover portion cooperating with the cradle portion to define an interior space for receiving the first end of the winding to space the first end from the first axial end surface of the stator tooth.

2. The cooling device of claim 1, wherein the cradle portion is C-shaped and the cover portion is planar.

3. The cooling device of claim 1, wherein the cradle portion includes a rounded projection over which the first end turn extends.

4. The cooling device of claim 1, wherein the cradle portion and cover portion cooperate to encircle the first end turn.

5. The cooling device of claim 1 further comprising a second cradle portion and a second cover portion that cooperate to define an interior space for receiving the second end of the winding to space the second end from the second axial end surface of the stator tooth.

6. The cooling device of claim 5, wherein the second cradle portion and second cover portion cooperate to encircle the second end turn.

7. The cooling device of claim 1, wherein the cradle portion and the cover portion are separate components secured together.

8. The cooling device of claim 1, wherein the cradle portion is positioned closer to the stator tooth than the cover portion such that the cradle portion removes heat generated at an inner portion of the first end turn of the winding and the cover portion removes heat generated at an outer portion of first end turn of the winding.

9. The cooling device of claim 1, wherein the cradle portion is aluminum.

10. The cooling device of claim 1, wherein the cover portion is aluminum.

11. A motor stator comprising:
a stator body centered on an axis and having a plurality of radially extending teeth spaced apart to define circumferential slots, each tooth having a first axial end surface and a second axial end surface
a motor winding wound around each tooth, each winding having a first end turn wound around the first axial end surface of each tooth and a second end turn wound around the second axial end surface of teach tooth;
a cooling device for removing heat from the first end turn, the cooling device including a cradle portion and a cover portion that cooperate to define an interior space for receiving the first end turn to space the first end turn from the first axial end surface of the stator tooth.

12. The motor stator of claim 11, wherein the cradle portion is C-shaped and the cover portion is planar.

13. The motor stator of claim 11, wherein the cradle portion includes a rounded projection over which the first end turn extends.

14. The motor stator of claim 11, wherein the cradle portion and cover portion cooperate to encircle the first end turn.

15. The motor stator of claim 11 further comprising a second cradle portion and a second cover portion that cooperate to define an interior space for receiving the second end of the winding to space the second end from the second axial end surface of the stator tooth.

16. The motor stator of claim 15, wherein the second cradle portion and second cover portion cooperate to encircle the second end turn.

17. The motor stator of claim 11, wherein the cradle portion and the cover portion are separate components secured together.

18. The motor stator of claim 11, wherein the cradle portion is positioned closer to the stator tooth than the cover portion such that the cradle portion removes heat generated at an inner portion of the first end turn of the winding and the cover portion removes heat generated at an outer portion of first end turn of the winding.

19. The motor stator of claim 11, wherein the cradle portion is aluminum.

20. The motor stator of claim 1, wherein the cover portion is aluminum.
